(19) United States
(12) Patent Application Publication
(10) Pub. No.: US 2026/0367607 A1
(43) Pub. Date: Nov. 19, 2026

(54) Computer-Implemented System and Method for Automated Pattern Generation and Manufacture of Custom Soft Goods and Other Pattern-Constructed Articles from Visual Input

(71) Applicants: Virginia Blaser, Lawrence, KS (US); Isabella Blaser, Lawrence, KS (US)

(72) Inventors: Virginia Blaser, Lawrence, KS (US); Isabella Blaser, Lawrence, KS (US)

(21) Appl. No.: 19/315,691

(22) Filed: Sep. 1, 2025

Related U.S. Application Data
(60) Provisional application No. 63/804,729, filed on May 13, 2025.

(51) Int. Cl. G05B 19/4097; G06Q 50/04

(52) U.S. Cl. CPC G05B 19/4097; G06Q 50/04; G05B 2219/36072

(57) ABSTRACT

A computer-implemented system and method for automated design and manufacture of custom soft goods and other articles from uncalibrated visual input. An artificial intelligence (AI) analysis module detects and classifies objects while performing metric dimensional recovery through a depth-calibration submodule that resolves scale ambiguity in monocular images. The submodule employs a transformer-based neural network trained on datasets with ground-truth dimensional labels, correlating pixel regions with object-class priors to achieve dimensional accuracy within ±5-10% for objects larger than 50 millimeters and mean error within approximately 3-5 millimeters for handheld devices. A customization module applies a rules engine to convert dimensional outputs into manufacturable patterns. A feedback mechanism validates design constraints including seam allowance, stitch density, and load distribution before export. A manufacturing integration module generates validated patterns as machine-readable files for automated equipment or as printable patterns for manual fabrication, with API-based acknowledgment of successful ingestion.

### CROSS-REFERENCE TO RELATED APPLICATIONS

This application claims the benefit of U.S. Provisional Patent Application No. 63/804,729, filed on May 13, 2025, the contents of which are incorporated herein by reference in their entirety.

### FIELD OF THE INVENTION

The present invention relates generally to computer-aided design and automated or manual manufacturing of articles constructed from patterns. More specifically, the invention pertains to computer-implemented systems and methods that utilize artificial intelligence to automatically generate manufacturable two-dimensional and three-dimensional patterns for custom soft goods from uncalibrated visual input, without fiducial markers, multi-view calibration, or external measuring devices, and to validate such patterns prior to export without requiring re-capture of images or manual measurements. The invention further applies, in some embodiments, to hybrid textile-rigid assemblies and other articles fabricated from patterns.

### Definitions

As Used Herein:

“Carry profile” means a structured data representation of the items to be accommodated in a custom soft good, including object-specific attributes (e.g., dimensions derived from image-based estimation, fragility, frequency-of-use, safety-critical designation) and textile-specific manufacturing parameters (e.g., seam allowance, stitch density, material flexibility, load distribution, reinforcement zones).

“Rules engine” means a system of programmed rules or constraints, implemented in software, hardware, or a combination, that is configured to transform a carry profile into a manufacturable 2D and/or 3D pattern by enforcing ergonomic constraints, functional requirements, and manufacturing tolerances. The rules engine is configured to allocate padding for fragile items, place quick-access compartments for safety-critical items, and optimize textile-specific tolerances, and is implemented using constraint-logic algorithms that enforce manufacturing rules.

“Textile-specific manufacturing parameters” means quantified design or production attributes affecting soft-goods fabrication, including but not limited to seam allowances (e.g., in millimeters), stitch density (e.g., stitches per inch), material tensile properties (e.g., megapascals), reinforcement placement, and pattern orientation relative to material grain.

“Manufacturable pattern” means a digital representation containing sufficient structural and manufacturing parameters to enable fabrication by either automated equipment or a human maker. In various embodiments, a manufacturable pattern includes a 2D file for automated textile fabrication (e.g., DXF, SVG, PDF) with embedded seam allowances, stitch-density specifications, cutting and labeling instructions, and optional piece-nesting coordinates; a 3D file (e.g., STL, OBJ, 3MF, AMF) defining printable geometry with per-region material, infill, or process-parameter metadata for additive manufacturing of rigid or semi-rigid components; or a printable pattern format (e.g., tiled PDF) intended for manual cutting, sewing, or hybrid construction.

“Machine-readable manufacturing file” means a file formatted for direct consumption by automated manufacturing equipment, including vector cut paths and piece labels for automated textile cutters (2D) or printable meshes with associated material/process metadata for additive manufacturing systems (3D).

“Feasibility constraints” means constraints evaluated prior to export, including seam-allowance thresholds, stitch-density ranges, minimum compartment dimensions derived from estimated object dimensions, simulated load distribution, and, in some embodiments, equipment-related limits such as cutter bed size, cut-path tolerances, or nesting efficiency.

“Safety-critical” means items whose failure or delayed access poses material risk to health or safety (e.g., medications, emergency gear), triggering dedicated placement and/or protection rules in the pattern.

“Uncalibrated visual input” means an image or video frame lacking an explicit scale reference or fiducial marker and not pre-calibrated by multi-view reconstruction or external measurement. “Interactive design session” means a session in which the system receives an image, computes a candidate pattern, applies constraint validation and any automatic adjustments, and outputs a validated manufacturable pattern without requiring the user to re-capture images or provide physical measurements.

“Acknowledgment message” means a response from a manufacturing system (e.g., via an API) indicating successful ingestion or acceptance of a transmitted machine-readable manufacturing file, and in some embodiments including a job identifier or equipment-capability profile.

### International Classification

G06T 7/00 (Image analysis; image processing)

G06F 17/50 (Computer-aided design [CAD])

D05B 3/00 (Sewing; sewing machines; sewing for textile manufacturing)

B33Y (Additive Manufacturing)

### BACKGROUND OF THE INVENTION

Consumers and professionals seeking functional articles—such as backpacks, tactical vests, medical kits, protective aprons, or specialized tool carriers—face a persistent challenge: mass-produced designs rarely match real-world needs. People often purchase and discard multiple products in pursuit of one that fits their items, preferences, and workflow, which leads to financial and environmental waste. Manufacturers similarly guess at demand, incurring material, labor, and distribution costs for inventory that may never sell.

Traditional customization is expensive, slow, and frequently inaccessible. Even newer digital platforms typically require users to enter measurements manually, describe needs in words, or choose from rigid option menus. These approaches rarely account for ergonomics, fragility, frequency of use, or access priority for the actual items a person carries, protects, or covers.

While AI-based vision has been applied in certain manufacturing contexts, especially for hard goods, no existing system successfully combines AI-based dimensional analysis from uncalibrated visual input with a rules engine that validates manufacturability prior to export. Existing CAD platforms for soft goods require manual measurement or 3D scanning and lack automated integration with textile-specific manufacturing rules. Known AI vision systems can identify and classify objects but typically cannot determine precise dimensions from a single 2D image without reference markers. Automated cutters accept vector patterns but do not generate such patterns directly from non-dimensional images.

The present invention uniquely combines image-based dimensional estimation, attribute inference, and rules-based validation to produce manufacturable patterns in a fully automated process, while also supporting printable patterns for manual fabrication. The invention provides a non-obvious combination of disparate technologies—computer vision, dimensional calibration, and manufacturing rule validation—to achieve a novel, automated or semi-automated manufacturing process not taught in the prior art.

### BRIEF SUMMARY OF THE INVENTION

The invention provides a computer-implemented system and method for automated design and manufacture of custom soft goods constructed from patterns. A user supplies an uncalibrated visual input, such as a standard photograph, depicting one or more physical objects intended to be carried or protected. A User Input Module receives the input. An AI Analysis Module processes the input to detect, classify, and, in some embodiments, segment objects, estimate their dimensions without fiducial markers, multi-view calibration, or manual measurements, and generate a carry profile including object-specific and textile-specific attributes such as fragility, frequency of use, safety-critical status, seam allowances, stitch density specifications, material flexibility, and load distribution targets. A Customization Module applies a rules engine to transform the carry profile into a manufacturable two-dimensional or three-dimensional pattern. A Feedback Mechanism validates manufacturability constraints prior to export, without requiring re-capture of images or manual measurements, and applies automatic adjustments or blocks export until constraints are satisfied. A Manufacturing Integration Module outputs the validated manufacturable pattern as either a machine-readable manufacturing file (e.g., DXF, SVG, PDF, STL, OBJ, 3MF, AMF) for automated equipment or a printable pattern for manual fabrication, and in some embodiments transmits machine-readable manufacturing files to automated cutting, sewing, or additive manufacturing equipment via an application programming interface and receives an acknowledgment of successful ingestion.

This invention provides a concrete technical improvement over conventional CAD workflows by enabling dimensional estimation and manufacturability validation directly from uncalibrated images without manual measurement, fiducial markers, or multi-view calibration. The system outputs validated manufacturable patterns as machine-readable manufacturing files or printable patterns, reducing error rates and human intervention while enabling scalable customization across consumer, professional, industrial, animal, and specialty applications.

### BRIEF DESCRIPTION OF THE DRAWINGS

FIG. 1 is a block diagram illustrating the components of the system, including the User Input Module, the AI Analysis Module, the Customization Module with an integrated rules engine, the Feedback Mechanism, and the Manufacturing Integration Module.

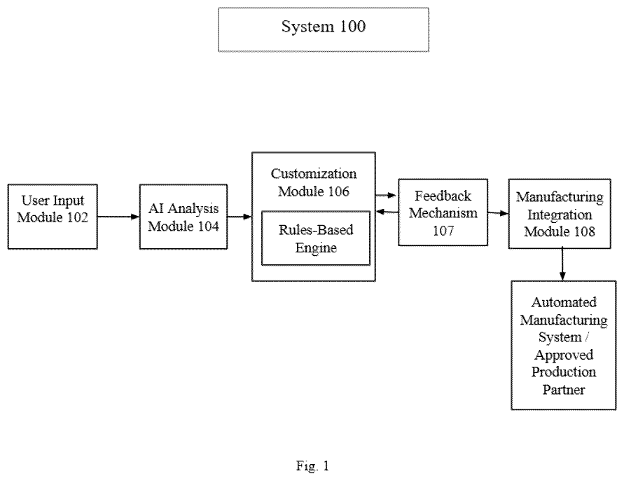

FIG. 2 is a perspective view illustrating an example configuration of the system, showing a user holding a smartphone functioning as the User Input Module, the smartphone displaying an image of various objects detected and analyzed by the AI Analysis Module, and the corresponding physical objects arranged on a surface.

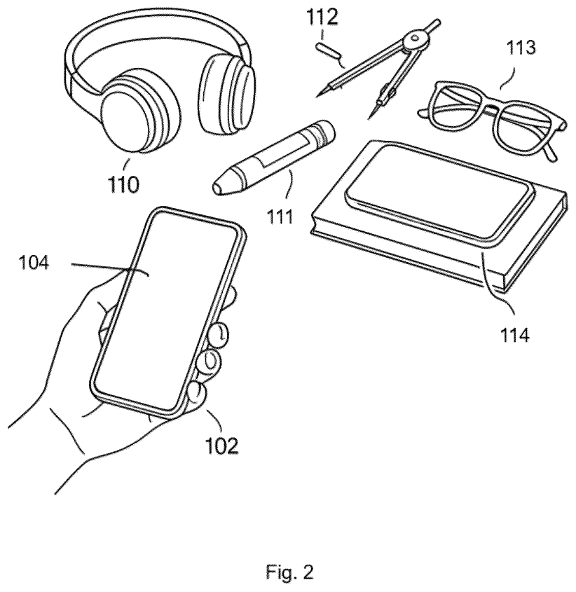

FIG. 3 is a schematic illustration of a representative customized soft good generated by the system, showing an example manufacturable pattern and corresponding compartments derived from the carry profile.

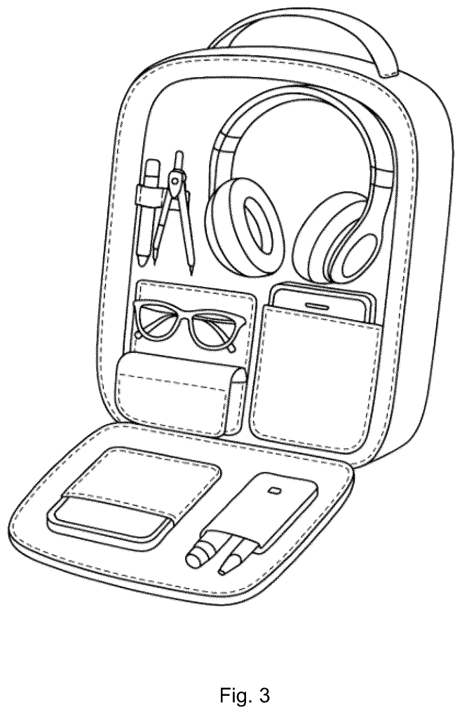

### DETAILED DESCRIPTION OF THE INVENTION

The system comprises a User Input Module configured to receive an uncalibrated visual input depicting one or more physical objects; an AI Analysis Module configured to perform object recognition, classification, segmentation, and dimensional estimation; a Customization Module that applies a rules engine; a Feedback Mechanism that validates manufacturability; and a Manufacturing Integration Module that generates and transmits files to production systems or provides printable patterns for manual fabrication. Each module is implemented by one or more processors executing stored program instructions and associated data structures.

The AI Analysis Module receives an uncalibrated visual input such as a photograph or video frame. It is configured to detect, classify, and, in some embodiments, segment objects, estimate their dimensions without fiducial markers, multi-view calibration, or manual measurements, and generate attributes used to construct the carry profile. In representative implementations, the object-detection backbone is a convolutional neural network, a transformer-based model, or a hybrid architecture. A depth-estimation head predicts scene depth or relative scale, and dimensional outputs are derived from the predicted depth and object geometry, optionally corrected by lens model assumptions. Unlike conventional image-recognition systems that produce only categorical labels, the AI Analysis Module provides concrete, real-world utility by generating metric object dimensions that directly drive manufacturing workflows.

In some embodiments, the AI Analysis Module includes a depth-calibration submodule specifically configured to resolve scale ambiguity in monocular depth estimation. The submodule employs a transformer-based neural architecture trained on datasets with ground-truth dimensional labels. The architecture correlates pixel regions with learned object-class dimensional priors to infer metric scale from a single uncalibrated image. This calibration pipeline achieves dimensional accuracy within approximately ±5-10% for objects larger than 50 millimeters, with validation tests showing mean absolute error within approximately 3-5 millimeters for typical handheld consumer items.

Dimensional estimation methods may include monocular depth prediction from a single image, stereo imaging from dual-camera input, or structure-from-motion from multiple frames. For example, in one representative embodiment, the module generates a depth map from a single uncalibrated image, combines the depth map with object masks and image intrinsics assumptions, and converts the result into object dimensions sufficient for pattern generation. When the system recognizes a known object class or model with published dimensions, it may retrieve those specifications from a database and use them as a calibration baseline to refine scale estimates for other objects in the same image.

In some embodiments, the AI Analysis Module achieves dimensional estimation accuracy within tolerances suitable for downstream textile and hybrid fabrication. For example, dimensional estimates may fall within approximately ±5-10% of true size for objects greater than 50 millimeters in a principal dimension, with validation testing demonstrating mean absolute error within approximately 3-5 millimeters for handheld electronic devices.

Worked Example: A smartphone detected in an image is estimated to have a width of approximately 70 millimeters with a ±3 millimeter error. Based on this dimensional estimate, the system applies seam allowance rules requiring a minimum of 5 millimeters, and stitch density rules specifying 8-10 stitches per inch for nylon fabric. The feedback mechanism simulates load distribution on the pattern; if predicted stress exceeds thresholds, the system automatically adds a reinforcement strip and increases stitch density to 12 stitches per inch at stress points before export.

In some embodiments, the dimensional estimation module implements a depth-calibration pipeline specifically configured to resolve metric scale from monocular, uncalibrated input. By fusing single-image depth prediction with class-specific dimensional anchors, the system outputs metric object dimensions without requiring fiducial markers, multi-view geometry, or external measurement devices. This mechanism directly addresses the longstanding technical problem of scale ambiguity in monocular vision systems, enabling manufacturable patterns to be generated from ordinary photographs.

In further embodiments, the Feedback Mechanism functions as a closed-loop safeguard against technical failures in automated manufacturing and manual fabrication. For example, the system automatically detects and blocks invalid cut paths, stitch-density violations, or seam allowances below machine tolerances before machine-readable files are transmitted to textile cutters, sewing machines, or additive manufacturing equipment, and flags manual fabrication risks before printable patterns are provided. By integrating this constraint validation into the pattern-generation loop, the invention ensures that only feasible manufacturable patterns are exported.

The carry profile includes ergonomic factors such as inferred hand dominance and reach zones, fragility levels, frequency-of-use indicators, safety-critical designations, and textile-specific manufacturing parameters such as seam allowance, stitch density, reinforcement zones, and pattern orientation.

The Customization Module applies a rules engine to transform the carry profile into a manufacturable two-dimensional or three-dimensional pattern. The rules include accessibility rules (high-frequency items placed externally), protection rules (padding for fragile items), ergonomic rules (strap angles between 15-30 degrees relative to the load plane), and manufacturability rules (minimum seam allowances and acceptable stitch densities for a given textile). In representative embodiments, the rules engine incorporates optimization algorithms for pattern nesting and cut-path efficiency to minimize waste.

The Feedback Mechanism validates the generated pattern against feasibility constraints prior to export and without requiring re-capture of images or manual measurements. Validation includes enforcing seam and stitch thresholds, checking minimum compartment sizes, and simulating load distribution. In some embodiments, the feedback mechanism executes a force-propagation model to identify stress points and automatically applies reinforcement rules before export. These feasibility constraints are enforced not only to confirm manufacturability within equipment limits but also to prevent structural defects and ensure that the fabricated article is functional, durable, and safe in real-world use.

The Manufacturing Integration Module outputs the validated manufacturable pattern as either a machine-readable manufacturing file for automated cutting, sewing, or additive manufacturing, or as a printable pattern for manual fabrication. Machine-readable files can embed seam allowances, stitch-density specifications, material usage labels, cutting instructions, and optional piece nesting coordinates, and may be transmitted via a RESTful API or equivalent protocol to manufacturing systems that return an acknowledgment message. Printable patterns can include tiled layouts, grain-line indicators, notches, labels, and assembly guidance for human makers.

In some embodiments, the modules are distributed across a client-server architecture, wherein mobile devices provide the user input interface, cloud-based servers execute the AI analysis and rules engine, and edge processors integrated with manufacturing equipment perform validation and ingestion of machine-readable files.

The system may log anonymized user interactions such as accepted suggestions, overrides, and rejected layouts to refine object recognition, carry-profile inference, and rule-based decisions. Data is stripped of personally identifiable information, optionally encrypted, and retained only with user consent. Over time, the system adapts dimensional estimation models, attribute inferences, and rules-engine parameters to improve accuracy and manufacturability of patterns across diverse article categories.

### ILLUSTRATIVE EMBODIMENTS

In some embodiments, a mathematics teacher may provide a smartphone photograph depicting the contents of a work bag. Detected objects may include a graphing calculator, a metal compass and steel protractor, a bento-style lunch box, a spiral-bound notebook, a USB-C charger, a handmade key fob, and a set of pens. The carry profile may specify a padded compartment for the calculator, a rigid sleeve for sharp tools, a stabilized insulated compartment for the lunch box, flat storage sleeves for the notebook and charger, and a quick-access pocket for the key fob. The Manufacturing Integration Module may output a machine-readable file for automated textile cutting or a printable pattern for manual cutting and sewing.

In some embodiments, a commuter who bicycles to work may provide a smartphone photograph including footwear, a laptop, a garment bag, and accessories. The system may allocate compartments dimensioned precisely to the user's actual load, balance weight for safe bicycle transport, and output either a machine-readable cutting file or a printable pattern for manual fabrication.

In some embodiments, a climber may upload a photograph including a belay device, carabiners, a chalk bag, a hydration bladder, gloves, an epinephrine injector, and a first-aid kit. The system may infer left-handed dominance and designate the injector as safety-critical with quick-access placement. The validated manufacturable pattern can be exported for automated or manual fabrication.

In some embodiments, a chef may provide a photograph of knives and specialty utensils. The carry profile may specify cut-resistant material placement and reinforced seams; the exported manufacturable pattern can include stitch-density requirements for high-risk regions.

In some embodiments, a service dog vest may be generated based on an input image including a hydration bladder, tracking device, and medication injector. The system may estimate girth range, specify compartments and reinforcements, and output either machine-readable files or printable patterns.

In some embodiments, a field technician may provide a photograph containing irregularly shaped tools, electronic meters, and protective eyewear. The system may generate a reinforced tool carrier pattern and export in either format.

In some embodiments, a medical technical carrier may be generated from an image including an oxygen cylinder and a portable defibrillator, with safety-critical placement and validated load-bearing stitch-density rules, exported for automated or manual fabrication.

### ADDITIONAL EMBODIMENTS

The system may generate patterns for bags, vests, harnesses, aprons, carriers, medical harnesses, protective vests, utility aprons, tool belts, load-bearing equipment, pet service vests, equine harnesses, camping gear, modular packs, oxygen carriers, medical device harnesses, protective equipment cases, hybrid textile-rigid assemblies, and other articles constructed from two-dimensional or three-dimensional patterns.

### CLOSING

The foregoing embodiments are provided for purposes of illustration and are not intended to be limiting. Various changes, substitutions, and alterations may be made without departing from the scope of the invention as defined by the appended claims.

1. A technical, computer-implemented system for resolving scale ambiguity in uncalibrated visual input and automatically generating validated, manufacturable patterns for custom soft goods, comprising: a User Input Module implemented by one or more processors and configured to receive an uncalibrated visual input depicting one or more physical objects; an AI Analysis Module operably connected to the User Input Module and configured to (i) detect, classify, and, in some embodiments, segment the objects, (ii) estimate dimensions of the objects from the uncalibrated visual input without fiducial markers, multi-view calibration, or manual measurements, and (iii) generate a carry profile including ergonomic factors, fragility, frequency-of-use, safety-critical designations, and textile-specific manufacturing parameters, wherein the AI Analysis Module includes a depth-calibration submodule employing a transformer-based neural network trained on datasets with ground-truth dimensional labels to resolve scale ambiguity in monocular images, achieving dimensional accuracy within approximately ±5-10% for objects larger than 50 millimeters and within approximately 3-5 millimeters for handheld devices; a Customization Module operably connected to the AI Analysis Module and configured to apply a rules engine that is configured to enforce manufacturing constraints by allocating padding for fragile items, designating quick-access compartments for safety-critical items, and enforcing seam allowance and stitch-density thresholds; a Feedback Mechanism operably connected to the Customization Module and configured to simulate load distribution on the candidate pattern, automatically reinforce stress points, and validate manufacturability constraints prior to export without requiring re-capture of images or manual measurements, thereby generating a validated manufacturable pattern; and a Manufacturing Integration Module configured to output the validated manufacturable pattern as (i) a machine-readable manufacturing file that, for a two-dimensional pattern, embeds seam allowance values, stitch density specifications, cut-path coordinates, and labeling data, and that, for a three-dimensional pattern, defines printable geometry and material metadata, and/or (ii) a printable pattern formatted for manual fabrication, and further configured, for machine-readable manufacturing files, to transmit the file to an automated manufacturing system via an application programming interface (API) and receive an acknowledgment message of successful ingestion.

2. The system of claim 1, wherein the acknowledgment message of successful ingestion includes at least one of a job identifier or an equipment-capability profile of the automated manufacturing system.

3. The system of claim 1, wherein the AI Analysis Module is configured to estimate object dimensions by generating a depth map from a single uncalibrated image using monocular depth prediction.

4. The system of claim 1, wherein the machine-readable manufacturing file for the two-dimensional pattern comprises a vector representation encoding explicit cut-path coordinates, notch or marker geometry, piece identifiers, and nesting coordinates consumable by automated cutting equipment.

5. The system of claim 1, wherein the machine-readable manufacturing file for the three-dimensional pattern conforms to 3MF or AMF and includes per-region material, infill density, or process-parameter metadata for additive fabrication of rigid or semi-rigid components.

6. The system of claim 1, wherein validating the candidate pattern comprises simulating load distribution to identify stress points and automatically adding structural reinforcement when required to satisfy a load-distribution constraint.

7. The system of claim 1, wherein the AI Analysis Module recognizes a known object, retrieves dimensional specifications for the known object from a database, and uses the retrieved specifications as a calibration baseline for estimating dimensions of other objects in the same image.

8. The system of claim 1, wherein the AI Analysis Module infers fragility based on contours or material classification and frequency-of-use based on co-occurrence with priority items.

9. The system of claim 1, wherein the system allows user overrides of inferred attributes but generates the carry profile automatically without requiring user input.

10. The system of claim 1, wherein the Customization Module retrieves seam allowance and stitch density values from a textile rules database and enforces them during pattern generation.

11. The system of claim 1, wherein the AI Analysis Module is configured to adapt object dimensional estimation models and attribute inferences based on anonymized user interaction data, including accepted suggestions, overrides, and rejected layouts.

12. The system of claim 1, wherein the Manufacturing Integration Module is configured to generate both a two-dimensional pattern and a three-dimensional manufacturing file for hybrid textile-rigid assembly fabrication.

13. A technical, computer-implemented method for designing and manufacturing a custom soft good, comprising: receiving, via a User Input Module implemented by one or more processors, an uncalibrated visual input depicting one or more physical objects; processing the uncalibrated visual input with an AI Analysis Module to (i) detect, classify, and, in some embodiments, segment the objects, (ii) estimate dimensions of the objects without fiducial markers, multi-view calibration, or manual measurements, and (iii) generate a carry profile including ergonomic factors, fragility, frequency-of-use, safety-critical designations, and textile-specific manufacturing parameters, wherein the AI Analysis Module includes a depth-calibration submodule employing a transformer-based neural network trained on datasets with ground-truth dimensional labels to resolve scale ambiguity in monocular images, achieving dimensional accuracy within approximately ±5-10% for objects larger than 50 millimeters and within approximately 3-5 millimeters for handheld devices; applying, with a Customization Module, a rules engine that is configured to enforce manufacturing constraints by allocating padding for fragile items, designating quick-access compartments for safety-critical items, and enforcing seam allowance and stitch-density thresholds, thereby generating a candidate manufacturable pattern; validating the candidate manufacturable pattern, with a Feedback Mechanism, by simulating load distribution, automatically reinforcing stress points, and confirming manufacturability constraints prior to export without requiring re-capture of images or manual measurements, thereby generating a validated manufacturable pattern; and outputting the validated manufacturable pattern as (i) a machine-readable manufacturing file that, for a two-dimensional pattern, embeds seam allowance values, stitch density specifications, cut-path coordinates, and labeling data, and that, for a three-dimensional pattern, defines printable geometry and material metadata, and/or (ii) a printable pattern formatted for manual fabrication; and, for machine-readable manufacturing files, transmitting the file to an automated manufacturing system via an application programming interface (API) and receiving an acknowledgment message of successful ingestion.

14. The method of claim 13, wherein estimating dimensions comprises generating a depth map from a single uncalibrated image using monocular depth prediction and converting the depth map into object dimensions for pattern generation.

15. The method of claim 13, wherein validating the candidate pattern includes executing a force-propagation model to identify stress points and applying reinforcement rules before designating the pattern as validated.

16. The method of claim 13, wherein generating the carry profile includes classifying at least one item as safety-critical and automatically setting a water-resistance requirement, a minimum padding thickness, and a quick-access placement bias according to a dominant-hand inference.

17. The method of claim 13, wherein the machine-readable manufacturing file for the two-dimensional pattern comprises a vector representation encoding explicit cut-path coordinates, notch or marker geometry, piece identifiers, and nesting coordinates consumable by automated cutting equipment.

18. The method of claim 13, wherein the machine-readable manufacturing file for the three-dimensional pattern conforms to 3MF or AMF and includes per-region material, infill density, or process-parameter metadata for additive fabrication of rigid or semi-rigid components.

19. The method of claim 13, wherein the acknowledgment message of successful ingestion includes at least one of a job identifier or an equipment-capability profile of the automated manufacturing system.

20. The system of claim 1, wherein the Customization Module incorporates optimization algorithms for material placement and pattern nesting to minimize waste and maximize structural integrity.

21. The system of claim 1, wherein the rules engine applies accessibility rules, ergonomic rules, protection rules, and manufacturability rules to generate the candidate pattern.

22. The system of claim 1, wherein the AI Analysis Module optionally uses stereo imaging or structure-from-motion applied to multiple frames to derive object dimensions and scale.

23. The system of claim 1, wherein the AI Analysis Module is trained on datasets including consumer electronics, medical devices, tools, and handmade articles to improve dimensional estimation accuracy.

24. The system of claim 1, wherein the system outputs both a validated manufacturable pattern and a three-dimensional rendering for user approval before manufacturing.

25. The method of claim 13, further comprising providing a three-dimensional rendering of the custom soft good to the user for review prior to final pattern generation.

26. The system of claim 1, wherein the article comprises a personal or consumer soft good selected from the group consisting of bags, vests, harnesses, aprons, or carriers.

27. The system of claim 1, wherein the article comprises a professional or industrial soft good selected from the group consisting of medical harnesses, protective vests, utility aprons, tool belts, or load-bearing equipment.

28. The system of claim 1, wherein the article comprises an outdoor or animal-use soft good selected from the group consisting of pet service vests, equine harnesses, camping gear, or modular packs.

29. The system of claim 1, wherein the article comprises a specialty or technical soft good selected from the group consisting of oxygen carriers, medical device harnesses, protective equipment cases, or hybrid textile-rigid assemblies.

30. The system of claim 1, wherein the article comprises any physical article constructed from a two-dimensional or three-dimensional pattern, including textile goods, hybrid assemblies, and irregularly shaped custom articles.

31. A computer-implemented system for automated design and manufacture of a custom article constructed from a pattern, comprising: a User Input Module implemented by one or more processors and configured to receive an uncalibrated visual input depicting one or more physical objects; an AI Analysis Module operably connected to the User Input Module and configured to (i) detect and classify the objects, (ii) estimate dimensions of the objects from the uncalibrated visual input without fiducial markers, multi-view calibration, or manual measurements, and (iii) generate a carry profile including ergonomic factors, fragility, frequency-of-use, safety-critical designations, and manufacturing parameters; a Customization Module operably connected to the AI Analysis Module and configured to apply a rules engine to transform the carry profile into a candidate manufacturable pattern; a Feedback Mechanism operably connected to the Customization Module and configured to validate the candidate pattern against manufacturability constraints prior to export and without requiring re-capture of images or manual measurements, and to block export until the constraints are satisfied or to automatically adjust the candidate pattern, thereby generating a validated manufacturable pattern; and a Manufacturing Integration Module configured to output the validated manufacturable pattern as a machine-readable manufacturing file and/or a printable pattern, and, for machine-readable manufacturing files, to transmit the file to an automated manufacturing system via an API and receive an acknowledgment message of successful ingestion.

32. The system of claim 31, wherein the acknowledgment message of successful ingestion includes at least one of a job identifier or an equipment-capability profile of the automated manufacturing system.

33. The system of claim 31, wherein the machine-readable manufacturing file for a two-dimensional pattern comprises a vector representation encoding cut-path coordinates, notches, piece identifiers, and nesting coordinates consumable by automated cutting equipment.

34. The system of claim 31, wherein the machine-readable manufacturing file for a three-dimensional pattern conforms to 3MF or AMF and includes per-region material, infill density, or process-parameter metadata for additive fabrication.

35. The system of claim 31, wherein validating the candidate pattern includes simulating load distribution and reinforcing stress points before export.

36. The system of claim 31, wherein the AI Analysis Module estimates object dimensions by generating a depth map from a single uncalibrated image using monocular depth prediction.

37. The method of claim 13, wherein physical manufacturing is performed by an external manufacturer who receives the validated manufacturable pattern and a materials list from the system.

38. A non-transitory computer-readable medium storing instructions that, when executed by one or more processors, cause a system to perform the method of claim 13.

39. The computer-readable medium of claim 38, wherein the instructions further cause the system to update the AI Analysis Module using anonymized user behavior data.

40. The computer-readable medium of claim 38, wherein the instructions further cause the system to generate both a manufacturable two-dimensional pattern and a three-dimensional manufacturing file for hybrid textile and semi-rigid component fabrication.

41. The method of claim 13, wherein the validating is performed during the same interactive design session in which the uncalibrated visual input is received.

42. The system of claim 1, wherein the validating is performed during the same interactive design session in which the uncalibrated visual input is received.

43. The system of claim 31, wherein the validating is performed during the same interactive design session in which the uncalibrated visual input is received.

44. A technical, computer-implemented system for resolving scale ambiguity in monocular depth estimation and generating validated manufacturable patterns, comprising: a depth-calibration submodule implemented by one or more processors and configured to generate metric depth estimations from a single uncalibrated image using a transformer-based neural network trained on datasets with ground-truth dimensional labels, the depth-calibration submodule achieving dimensional accuracy within approximately ±5-10% for objects exceeding 50 millimeters and within approximately 3-5 millimeters for handheld devices, without requiring fiducial markers, multi-view calibration, or external measurement devices; a pattern validation module operably connected to the depth-calibration submodule and configured to receive dimensional data and apply feasibility constraints comprising seam-allowance thresholds, stitch-density ranges, and simulated load distribution, automatically reinforcing stress points when required, thereby generating a validated manufacturable pattern; and a manufacturing integration module configured to output the validated manufacturable pattern as (i) a machine-readable manufacturing file, in a format selected from the group consisting of DXF, SVG, STL, OBJ, 3MF, and AMF, embedding seam allowance values, stitch density specifications, cut-path coordinates, and labeling data for automated equipment, and/or (ii) a printable pattern formatted for manual fabrication, and, for machine-readable manufacturing files, to transmit the file to an automated manufacturing system via a standardized data exchange protocol, including a RESTful API with JSON payloads, and to receive an acknowledgment message of successful ingestion; wherein the validated manufacturable pattern is generated during the same interactive design session in which the uncalibrated visual input is received, without requiring the user to re-capture images or provide physical measurements.
